(19) United States
(12) Patent Application Publication
(10) Pub. No.: US 2026/0321112 A1
(43) Pub. Date: Oct. 15, 2026

(54) SURVEILLANCE UNITS INCLUDING THERMAL CAMERA DEVICES INCLUDING HEATING DEVICES, AND RELATED THERMAL CAMERA DEVICES AND METHODS

(71) Applicant: LiveView Technologies, LLC, American Fork, UT (US)

(72) Inventor: Richard C. Lindsey, Payson, UT (US)

(73) Assignee: Live View Technologies, LLC, American Fork, UT (US)

(21) Appl. No.: 19/642,281

(22) Filed: Apr. 8, 2026

Related U.S. Application Data
(60) Provisional application No. 63/787,326, filed on Apr. 11, 2025.

(51) Int. Cl. G08B 13/196; G01J 5/061

(52) U.S. Cl. CPC G08B 13/19621; G01J 5/061; G08B 13/19619; G08B 13/19626; G08B 13/19632; G08B 13/19636; G01J 2005/063

(57) ABSTRACT

Various embodiments relate to surveillance units and methods of operating surveillance units. A surveillance unit may include a portable trailer, a mast coupled to the portable trailer, and at least one thermal camera device coupled to the mast. The at least one thermal camera device comprises a heater printed circuit board assembly device including one or more resistors, a carrier board attached to the heater device, a camera socket attached to the carrier board, and a thermal camera including a shutter attached to the camera socket. Related systems, surveillance units, and methods are also disclosed.

### CROSS-REFERENCE TO RELATED APPLICATION

This application claims the benefit of the filing date of United States Provisional Patent Application Serial No. 63/787,326, filed Apr. 11, 2025, for “HEATING DEVICES, AND ASSOCIATED UNITS, DEVICES, SYSTEMS, AND METHODS,” the entire disclosure of which is incorporated herein in its entirety by this reference.

### TECHNICAL FIELD

This disclosure relates generally to heating devices, and more specifically to heating devices for heating a sensor (e.g., a camera), and to related units, devices, systems, and methods. More particularly, this disclosure relates to a device including a thermal camera and a heater printed circuit board assembly for heating the thermal camera used in a surveillance unit to facilitate use of the surveillance unit in low temperature conditions, and to related surveillance units, devices, systems, and methods.

### BACKGROUND

Recent years have witnessed significant growth in both hardware and software within the field of mobile security. A prime example of these advancements is mobile surveillance units (MSUs), which can be deployed across diverse environments to provide on-demand security monitoring and deterrence.

A mobile surveillance unit may utilize one or more cameras and/or one or more sensors for analyzing the environment in which the mobile surveillance unit is deployed. The mobile surveillance unit may include various models, such as machine learning models and other deep learning models, that are applied to camera data and sensor data to analyze the environment and generate one or more outputs indicative of the environment, which may be provided to a user device that is remote from the mobile surveillance unit and/or to generate one or more alerts.

As described above, the surveillance units may be deployed across diverse environments. For example, the mobile surveillance units may be deployed in environments where the ambient temperature falls below a design temperature of the cameras and/or sensors. In some embodiments, the ambient temperature falls below a minimum design temperature for the cameras and/or sensors, causing the cameras and/or sensors to fail.

### BRIEF SUMMARY

Embodiments disclosed herein include a surveillance unit including a portable trailer, a mast coupled to the portable trailer, and at least one thermal camera device coupled to the mast. The at least one thermal camera device comprises a heater device including one or more resistors, a carrier board attached to the heater device, a camera socket attached to the carrier board, and a thermal camera including a shutter attached to the camera socket.

According to some embodiments, a device comprises a heater device including one or more resistors configured to generate heat, a carrier board coupled to the heater device via a thermal material, and a thermal camera attached to the carrier board.

According to some embodiments, a method of operating a surveillance unit including a thermal camera comprises deploying a surveillance unit including a thermal camera device comprising a heater printed circuit board assembly and a thermal camera assembly at a location, responsive to a temperature measured by the thermal camera device falling below a minimum threshold temperature, providing power to a heating element of the heater printed circuit board assembly, and transferring thermal energy from the heater printed circuit board assembly to the thermal camera assembly through a thermal material to increase the temperature of the thermal camera.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

FIG. 1 is a perspective view of a system including a surveillance unit, in accordance with various embodiments of the disclosure.

FIGS. 2A and 2B are examples of a surveillance unit, in accordance with various embodiments of the disclosure.

FIG. 3A is a simplified cross-sectional view of a device including a thermal camera assembly and a heater printed circuit board assembly, in accordance with various embodiments of the disclosure.

FIG. 3B is a simplified cross-sectional view of a device package including the device in an enclosure, in accordance with various embodiments of the disclosure.

FIG. 3C is a simplified perspective view of the device package in a sealed assembly, in accordance with various embodiments of the disclosure.

FIG. 3D is a simplified top-down view of a heater printed circuit board assembly showing a layout of the resistors thereon, in accordance with various embodiments of the disclosure.

FIG. 3E is a simplified top-down view showing a layout of how resistors could be arranged on the printed circuit board assembly, in accordance with various embodiments of the disclosure.

FIG. 3F is a simplified top-down view of a heating element, in accordance with various embodiments of the disclosure.

FIG. 3G is a simplified planar view of the heater device from a bottom of the heater device, in accordance with various embodiments of the disclosure.

FIG. 4A is a simplified cross-sectional view of a thermal camera assembly, in accordance with various embodiments of the disclosure.

FIG. 4B is a simplified perspective view of the thermal camera of FIG. 4A, in accordance with various embodiments of the disclosure.

FIG. 4C is a simplified top-down view of the thermal camera of FIG. 4A, in accordance with various embodiments of the disclosure.

FIG. 5 is a simplified top-down view of a carrier board of the thermal camera assembly, in accordance with various embodiments of the disclosure.

FIG. 6 is a simplified schematic of an example circuit of the heater printed circuit board assembly, in accordance with various embodiments of the disclosure.

FIG. 7 is a simplified schematic of another example circuit of the heater printed circuit board assembly, in accordance with various embodiments of the disclosure.

FIG. 8 is a simplified flow diagram illustrating a method of operating a mobile surveillance unit, in accordance with various embodiments of the disclosure.

### DETAILED DESCRIPTION

Referring in general to the accompanying drawings, various embodiments of the disclosure are illustrated to show example embodiments related to heating devices for sensors (e.g., cameras). It should be understood that the drawings presented are not meant to be illustrative of actual views of any particular portion of an actual circuit, device, system, or structure, but are merely representations which are employed to more clearly depict various embodiments of the disclosure.

The following provides a more detailed description of the present disclosure and various representative embodiments thereof. In this description, functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

The present disclosure utilizes a variety of terms to describe features and advantages of one or more embodiments of a device including a thermal camera and a heater printed circuit board assembly configured to heat the thermal camera, and an associated surveillance unit described herein. Additional detail will now be provided regarding some of these terms. It will be appreciated that this description of these terms is not the complete or full meaning of these terms, but is provided as an aid in the following description. Additional features of the terms used herein may be drawn from examples and other embodiments described herein.

In one or more embodiments, a “surveillance unit” may include a mobile surveillance unit (or a “mobile unit” or a “mobile security unit”) and may refer to a security and/or surveillance system, device, or set of devices that form a cohesive unit to surveil a designated area. For example, a surveillance unit may be a security trailer or other portable device with surveillance components (e.g., cameras, lights, measurement sensors) and computational components for capturing, storing, processing, and/or providing surveillance data at a deployed location. In some implementations, a surveillance unit includes alert or output components (e.g., lights, speakers, sirens) for deterring malicious actions at the deployed location or against the mobile unit.

The present disclosure relates to systems, methods, and computer-readable media for operating a surveillance unit (e.g., a mobile surveillance unit) including a thermal camera in environments where the ambient temperature may fall below a minimum threshold ambient temperature. The surveillance unit may include a head unit including one or more cameras (e.g., one or more visible cameras) and/or one or more thermal cameras configured to capture one or more thermal images or thermal data from the environment surrounding the surveillance unit. In some embodiments, the surveillance unit includes a thermal camera device attached to, for example, a mast of the surveillance unit proximate the head unit.

The thermal camera device may include a thermal camera assembly in operable communication with a heater device. The thermal camera assembly may include a thermal camera configured to operate in the infrared (IR) spectrum. The thermal camera may detect (e.g., monitor) objects that create a heat signature, such as, but not limited to, human bodies, animals, and inanimate objects, to determine their unique characteristics in the IR spectrum (e.g., from about 700 nm to about 1,000 nm). Thus, the thermal camera may be configured to generate thermal images (e.g., IR images) and/or thermal data (e.g., IR data) of the environment surrounding the surveillance unit.

The thermal camera may be configured to calibrate (e.g., self-calibrate) by closing a shutter of the thermal camera and performing a calibration operation when the shutter is closed. Closing the shutter during the calibration operation blocks incoming IR radiation to provide a uniform, known temperature source (e.g., the shutter) to a thermal detector of the thermal camera. The uniform temperature source facilitates improved calibration of the thermal camera. The calibration operation facilitates generating more accurate thermal image data of the environment and improves operation of the surveillance unit. Unfortunately, opening and closing the shutter when the thermal camera is at a temperature lower than a minimum threshold design temperature (e.g., lower than about 0°C) may cause mechanical failure of the shutter. Thus, many thermal cameras are designed not to calibrate when temperatures fall below about 0°C. However, there are many applications of the surveillance unit in which it is desired for the thermal camera to operate below about 0°C, such as at temperatures as low as about -40°C.

According to embodiments disclosed herein, the thermal camera is in operable communication with a heater device (also referred to as a “heater board” or a “heating system”). For example, the heater device may be in operable communication with a carrier board (e.g., a printed circuit board) of the thermal camera. The heater device may include a heating element, a circuit to enable and disable the heating element, and a switch (e.g., a thermostat) including a thermal sensor to detect a temperature (e.g., an ambient temperature, a temperature of the thermal camera) and provide a control signal to the circuit. The switch may be in operable communication with a transistor configured to provide a control signal to the resistors. The transistor may be, for example, a P-Channel or N-channel FET, the gate of which may be controlled by the switch. The switch may include a temperature sensing IC chip that outputs a signal compatible with the gate signal required by the transistor.

The heater device may include a number of surface mount resistors wired in a series, series/parallel, or parallel configuration to achieve the desired load value (e.g., heating value) and to cover a desired surface area depending on the specific need of the thermal camera (e.g., the surface area of the thermal camera). Forming the heater device with the surface mount resistors facilitates forming the heater device to create a desired pattern of the heating element and provide uniform heating to the thermal camera based on the shape and needs of the thermal camera. The heater device may power the heating element, which provides heat to the thermal camera, enabling the thermal camera to operate (and calibrate) even when the ambient temperature is as low as about -40°C.

A thermal material may interface between the heater device and the carrier board of the thermal camera, facilitating a substantially uniform thermal transfer from the heater device to the thermal camera and a substantially uniform temperature profile across the thermal camera. The thermal material may include a thermally conductive tape, putty, or other suitable thermal transfer medium. By integrating the thermal material between the heater device and the thermal camera, the heater device provides a substantially uniform temperature profile to the thermal camera, which are generally particularly sensitive to variations in temperature. Coupling the heater device to the carrier board of the thermal camera facilitates implementing the heater device with different types of commercially available thermal cameras. Accordingly, the heater device may be integrated and easily adapted to different applications and types of thermal cameras. The device including the heater device and the thermal camera may be mounted in a protective enclosure which may reduce (e.g., prevent) outside air from entering the enclosure and maintain the internal temperature (e.g., of the thermal camera) at a desired temperature, and provide mechanical stability to the device.

Although various embodiments are described herein with reference to security and/or surveillance systems and/or mobile security and/or mobile surveillance units, the present disclosure is not so limited, and the embodiments may be generally applicable to any system and/or device that may or may not include security and/or surveillance systems and/or units. Further, although some embodiments are disclosed with reference to a mobile unit, the disclosure is not so limited, and a person having ordinary skill will understand that various embodiments may be applicable to other systems and devices, such as stationary units (e.g., a unit coupled to a stationary pole (e.g., a light pole), a structure (e.g., of a business or a residence), a tree, etc.). Embodiments of the disclosure will now be explained with reference to the accompanying drawings.

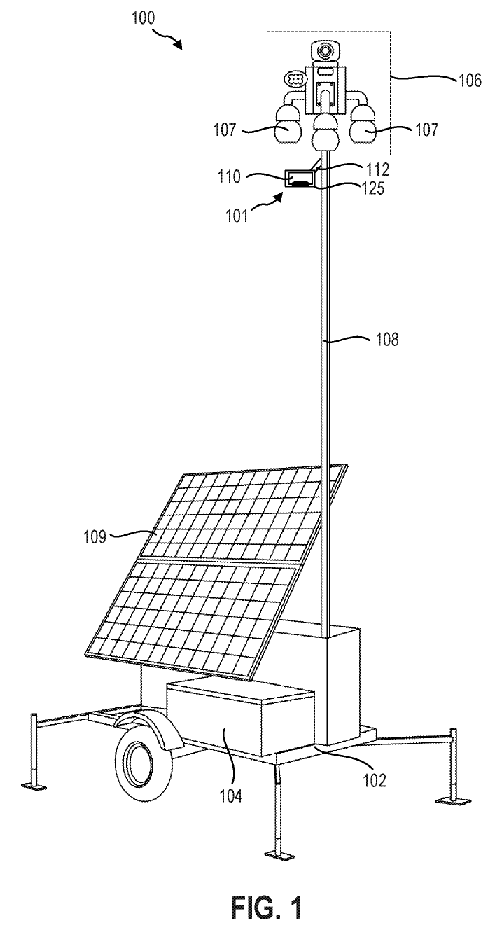

FIG. 1 is a perspective view of a system including a surveillance unit 100, in accordance with various embodiments of the disclosure. The surveillance unit 100, which may also be referred to herein as a “mobile unit,” a “mobile surveillance unit,” a “mobile security unit,” an “MSU,” a “live unit,” a “physical unit,” “a surveillance unit,” or some variation thereof, may be configured to be positioned in an environment (e.g., a parking lot, a roadside location, a construction zone, a concert venue, a sporting venue, a school campus, without limitation). In some embodiments, surveillance unit 100 includes one or more sensors (e.g., cameras, weather sensors, motion sensors, noise sensors, without limitation) and one or more output devices (e.g., lights, infrared (IR) sensors, speakers, electronic displays, without limitation). The surveillance unit 100 may also include at least one storage device (e.g., internal flash media, a network attached storage device, or any other suitable electronic storage device), which may be configured for receiving and storing data (e.g., video, images, audio, without limitation) captured by one or more sensors of surveillance unit 100.

In some embodiments, surveillance unit 100 includes a mobile security/surveillance unit. In some embodiments, the surveillance unit 100 is not a mobile surveillance unit. In these and other embodiments, surveillance unit 100 may include a portable trailer 102, a storage box 104, and a mast 108 coupled to a head unit 106 which may include, for example, one or more batteries, one or more cameras, one or more sensors, controllers/processors or other electronics, one or more lights, one or more speakers, and/or one or more microphones.

During transport or storage of the surveillance unit 100, one or more components of the surveillance unit 100 may be removed from the surveillance unit 100, the mast 108, or the head unit 106. In some embodiments, the mast 108 is an extendable or deployable mast and may be extended or deployed at the time of deployment of the surveillance unit 100 in a field location. The mast 108 supports the head unit 106 and may include an extendable pole that is retracted while the surveillance unit 100 is being transported and extended when the surveillance unit 100 is secured at a deployed location. Upon deployment of the surveillance unit 100, the mast 108 may be connected to the trailer 102 and/or storage box 104 at a first end, and the head unit 106 may be positioned at an elevated position at a second, opposite end of mast 108. According to some embodiments, a first end of mast 108 may be proximate to the storage box 104, and a second, opposite end of mast 108 may be proximate, and possibly adjacent, to head unit 106. More specifically, in some embodiments, head unit 106 may be coupled to mast 108 at an end opposite to an end of mast 108 proximate to storage box 104.

The portable trailer 102 may be configured to facilitate transporting the surveillance unit 100. The storage box 104 may be configured to facilitate storage of one or more components of the surveillance unit 100, such as one or more primary batteries. The storage box 104 may also be configured to carry one or more power sources in addition to the primary batteries, such as generators (e.g., fuel cell generators).

In some embodiments, the surveillance unit 100 may include one or more primary batteries (e.g., within storage box 104) and one or more secondary batteries (e.g., within head unit 106). In these embodiments, a primary battery positioned in storage box 104 may be coupled to a load and/or a secondary battery positioned within head unit 106 via, for example, a cord reel.

In some embodiments, the surveillance unit 100 includes at least one computing device and/or other electronics powered by the one or more batteries. In some embodiments, valuable devices (e.g., hardware) may be securely housed in storage box 104 and in data communication with head unit 106 and/or a thermal camera device 110. For example, head unit 106 and/or the thermal camera device 110 may each include one or more sensors, one or more cameras, and/or one or more output devices; and a computing device (e.g., in head unit 106 or storage box 104) may receive data from the one or more sensors and/or cameras, and/or the computing device may transmit instructions to the one or more output devices. As described above, in some embodiments, storage box 104 securely houses one or more hardware storage devices. The one or more storage devices may be in data communication with and/or integrated with the one or more computing devices.

In some embodiments, the surveillance unit 100 may also include one or more power sources and/or power supplies. For example, the surveillance unit 100 may include or be in electrical communication with one or more solar panels 109, which may provide power to one or more batteries of the surveillance unit 100. More specifically, according to some embodiments, one or more solar panels 109 may provide power to a primary battery within the storage box 104. In some embodiments, the surveillance unit 100 may also include other power sources, such as one or more generators. For example, the storage box 104 may include a fuel cell generator and/or another power generator.

The head unit 106 may include one or more sensors, visible spectrum cameras, thermal cameras, infrared (IR) cameras, IR sensors, and processing components (e.g., computing devices) that capture, process, and store surveillance data. In some embodiments, the head unit 106 includes one or more cameras 107. The cameras 107 may each include one or more thermal cameras, one or more visible cameras, an ultraviolet camera, a hyperspectral camera, and/or one or more other cameras. Non-limiting examples of thermal cameras include an infrared (IR) camera, a short-wave infrared (SWIR) camera, a long-wave infrared (LWIR) camera, a LWIR detection sensor, or another type of infrared camera. In some embodiments, the visible cameras include red green blue (RGB) cameras. In some embodiments, at least one of (e.g., each of) the cameras 107 includes a visible camera (e.g., an RGB camera) and a thermal camera and may be referred to as a “bi-spectral camera.” In some embodiments, the cameras 107 are visible spectrum cameras.

The head unit 106 and the thermal camera device 110 may include hardware and software computing elements that allow the surveillance unit 100 to serve as an edge unit. In some embodiments, the head unit 106 also includes input and output devices, such as one or more lights (e.g., flood lights, strobe lights, LED lights, or other lights), speakers (e.g., loudspeakers, one-way speakers, two-way public address (PA) speaker systems, or any other suitable speaker), microphones, display devices (e.g., digital display devices), and/or other suitable output devices. In some embodiments, some components of the head unit 106 may also be located elsewhere on the surveillance unit 100, such as in the storage box 104. The head unit 106 may also include batteries or other power components. In some embodiments, the head unit 106 is referred to as a “live unit.”

With continued reference to FIG. 1, the surveillance unit 100 may further include the thermal camera device 110, which may be attached to the mast 108. Although FIG. 1 illustrates the thermal camera device 110 attached to the mast 108, in some embodiments, the thermal camera device 110 is part of the head unit 106. In particular, when mounted, the thermal camera device 110 is oriented to be downward-facing to capture a top-down view of the surveillance unit 100 and its surrounding area. In various implementations, the thermal camera device 110 is offset (e.g., 6 inches, 1 foot, or 2 feet) from the mast 108 to provide a fuller field of view (FOV) while also ensuring mounting stability. Additionally, the thermal camera device 110 may include cables (e.g., a USB cable) or other connection cords to connect the thermal camera device 110 to the processing components at the head unit 106. In various implementations, the thermal camera device 110 is included with, mounted on, and/or integrated into the head unit 106. The thermal camera device 110 may be affixed to the surveillance unit 100 in a way that does not obstruct the FOV of the cameras 107.

In some embodiments, the thermal camera device 110 is associated with a mast mounting bracket 112 and an enclosure 125. The enclosure 125 and the thermal camera device 110 form a thermal camera device package 101. For example, and as described in additional detail herein, the thermal camera device 110 may include a thermal camera attached to a carrier board (e.g., a printed circuit board with communication ports). The carrier board may be secured within the enclosure 125 that surrounds and protects the thermal camera device 110 from environmental elements and tampering. The carrier board may be secured to the enclosure 125 via a camera mounting bracket. In some instances, foam or other padding is used to secure the thermal camera device 110 and/or carrier board within the enclosure 125 to provide resilience against movement and impacts. In various implementations, compressive foam is implemented in such a way that it does not block or clip the camera field of view. Furthermore, the enclosure 125 may be fastened to the mast mounting bracket 112, which attaches to the mast 108.

The thermal camera of the thermal camera device 110 may be configured to capture a thermal video stream (e.g., IR video) and/or thermal images of the field of view of the thermal camera. In some embodiments, the thermal camera is an infrared (IR) camera or another type of thermal camera. In some embodiments, the thermal camera includes an LWIR micro thermal camera module. The thermal camera may be an LWIR camera, such as a Lepton LWIR micro thermal camera module (or another Lepton thermal camera).

In various implementations, the thermal camera provides a low-resolution (e.g., 160×120 pixels) thermal video stream from the surveillance unit 100. In some implementations, the resolution is higher, including high-definition, ultra-high-definition, or other higher resolutions.

In operation, the cameras 107 and the thermal camera of the thermal camera device 110 may capture image data and/or video data comprising images and/or videos of the surveillance unit 100 and/or of a proximity of the surveillance unit 100. Based on the image data and/or the video data captured by the camera(s), an alert system of the surveillance unit 100 may activate one or more alert protocols, which may include lights and/or speakers on the surveillance unit 100.

As described herein, the thermal camera device 110 including the thermal camera may operate in most outdoor conditions (e.g., the thermal camera, enclosure, and cabling may be suitable for UV exposure, precipitation, humidity, and temperatures (such as from about -40ºC to about 50°C)). In instances where the ambient temperature surrounding the thermal camera device 110 (and the surveillance unit 100) falls below about 0°C, the thermal camera may not be able to operate as intended. In some embodiments, the thermal camera of the thermal camera device 110 includes a shutter configured to open and close. The thermal camera may perform a calibration operation wherein the shutter is closed to provide an object with a substantially uniform temperature profile (e.g., the shutter) to facilitate the calibration operation. However, the shutter may not open and close at temperatures below about 0°C. According to embodiments described herein, the thermal camera device 110 may include a device in operable and thermal communication with the thermal camera, the heater device configured to heat the thermal camera and allow the thermal camera to operate and perform calibration operations, even when the thermal camera is exposed to ambient temperatures below about 0°C, such as below about -10°C, below about -20°C, below about -30°C, or even below about -40°C.

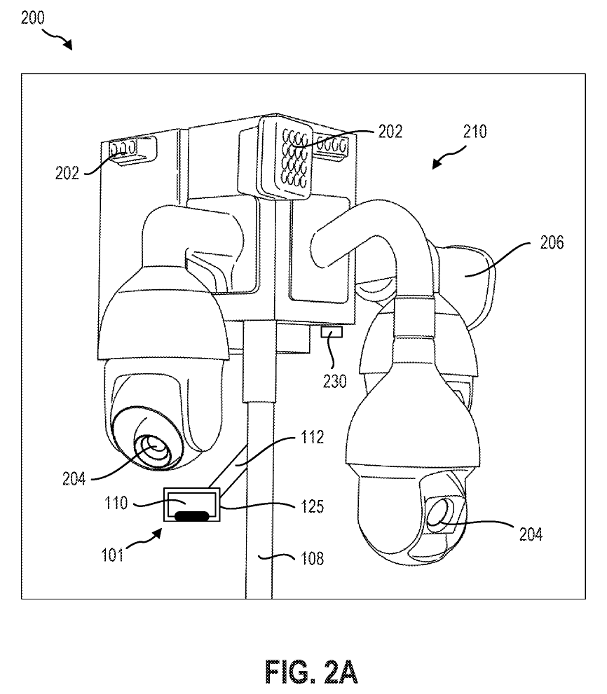

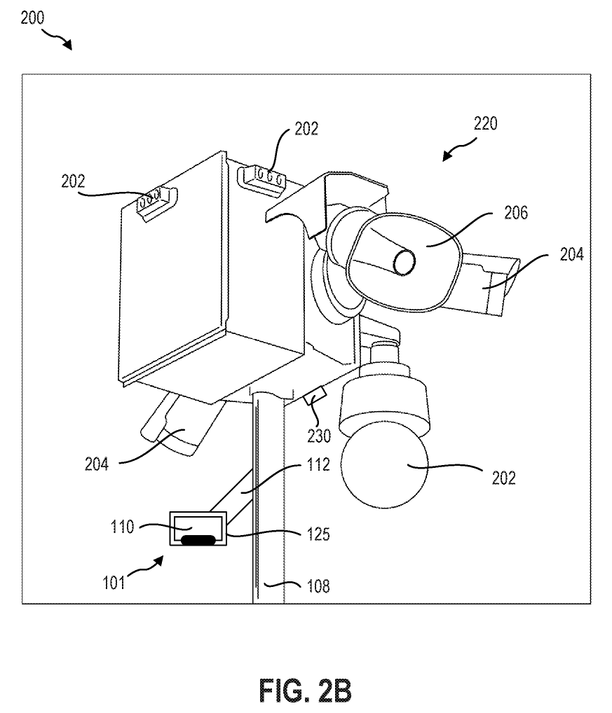

Non-limiting examples of the surveillance unit 100 are shown in FIGS. 2A and 2B, in accordance with various embodiments of the disclosure. More specifically, FIG. 2A illustrates a portion 200 of a surveillance unit including a head unit 210 having a number of lights 202, a number of camera assemblies 204, and a speaker 206; and FIG. 2B is another depiction of a portion 200 of a surveillance unit including a head unit 220 having a number of lights 202, a number of camera assemblies 204, and a speaker 206. The surveillance units and the head units 210, 220 may correspond to the respective surveillance unit 100 and head unit 106 in FIG. 1. The camera assemblies 204 may each include at least one camera, such as one or more of the cameras 107 described above.

The surveillance units may further include at least one thermal camera device package 101 including a thermal camera device 110, which may correspond to the thermal camera device package 101 and the thermal camera device 110 described above. In some embodiments, the thermal camera device package 101 is attached to the mast 108 with a mast mounting bracket 112 or other mounting mechanism. As another example, the thermal camera device package 101 may be attached to the mast 108 with a clamp or other biasing means.

The thermal camera device 110 may include an IR camera or another type of thermal camera. By way of non-limiting example, the thermal camera may comprise an LWIR camera. In some embodiments, in addition to the thermal camera device 110, at least one of the camera assemblies 204 comprises an IR camera, such as those described above with reference to the thermal camera of the thermal camera device 110. In some embodiments, thermal cameras associated with the camera assemblies 204 may include a higher resolution camera than the thermal camera of the thermal camera device 110.

In addition to the camera assemblies 204 and the thermal camera device 110, the surveillance unit may include one or more sensors 230 configured to detect at least one condition of the environment surrounding the surveillance unit. By way of non-limiting example, the sensor 230 may include one or more of a weather sensor, motion sensor, noise sensor, or a thermal sensor (e.g., an IR sensor). In some embodiments, the sensor 230 includes a thermal sensor.

One or more of the sensors 230, the cameras of the camera assemblies 204, or the thermal cameras of the thermal camera devices 110 of a surveillance unit (e.g., surveillance unit 100) may include and/or may be coupled to one or more heating devices, as described herein. In particular, in some embodiments, the surveillance unit 100 may be deployed in environments wherein the ambient temperature may fall below a minimum design threshold temperature for one or more components of the surveillance unit 100, such as one or more components of the thermal camera (e.g., a shutter of the thermal camera) and/or one or more components of the head unit 106. In some embodiments, one or more of the thermal camera, the camera assemblies 204, and/or one or more sensors 230 may be designed to operate above a minimum design temperature.

As only one non-limiting example, a thermal camera may not operate effectively below a minimum threshold temperature, such as below about 0°C, due to one or more mechanical limitations that occur at such temperatures. For example, a shutter of the thermal camera may not operate effectively below the minimum threshold temperature. However, it may be desired to deploy the surveillance unit 100 in environments where the ambient temperature falls below the minimum threshold temperature (e.g., below about 0°C). According to embodiments described herein, the surveillance unit 100 may be deployed in environments where the ambient temperature falls below about 0°C, and the thermal camera of the surveillance unit 100 may operate effectively. In some embodiments, the thermal camera operates in ambient conditions as low as about -40°C. However, the ambient temperature in which the surveillance unit 100 may operate is not particularly limited, and the surveillance unit 100 may be deployed in environments with different ambient temperatures.

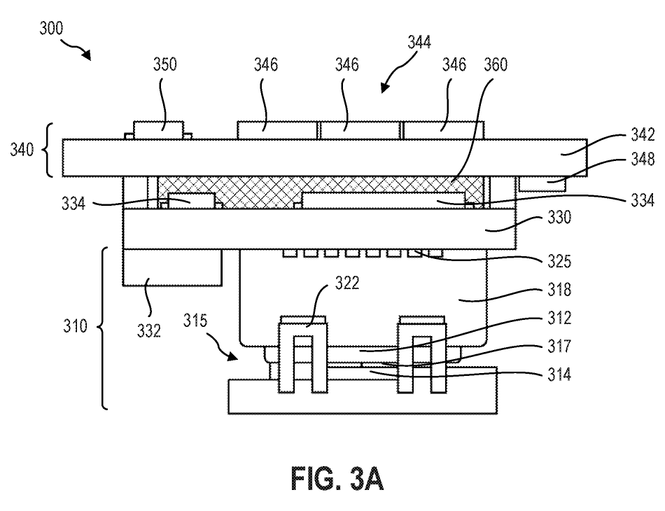

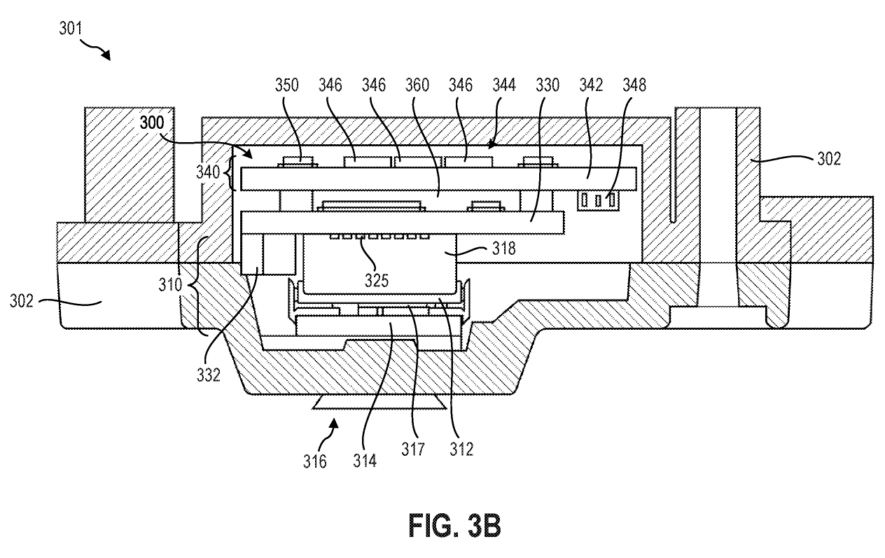

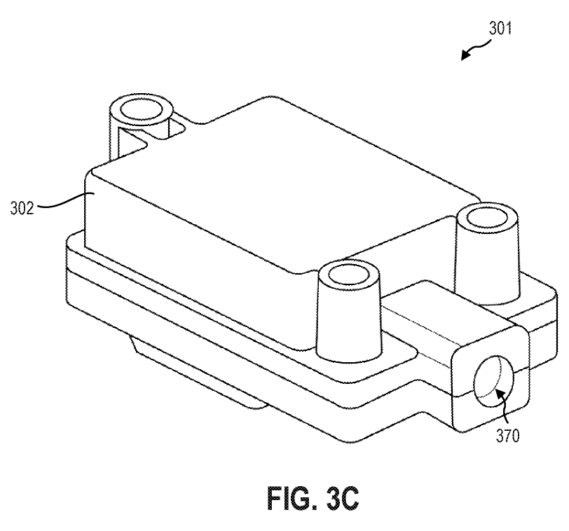

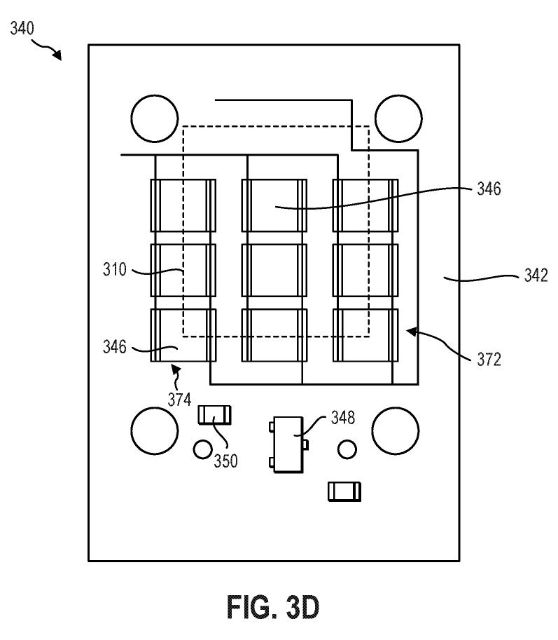

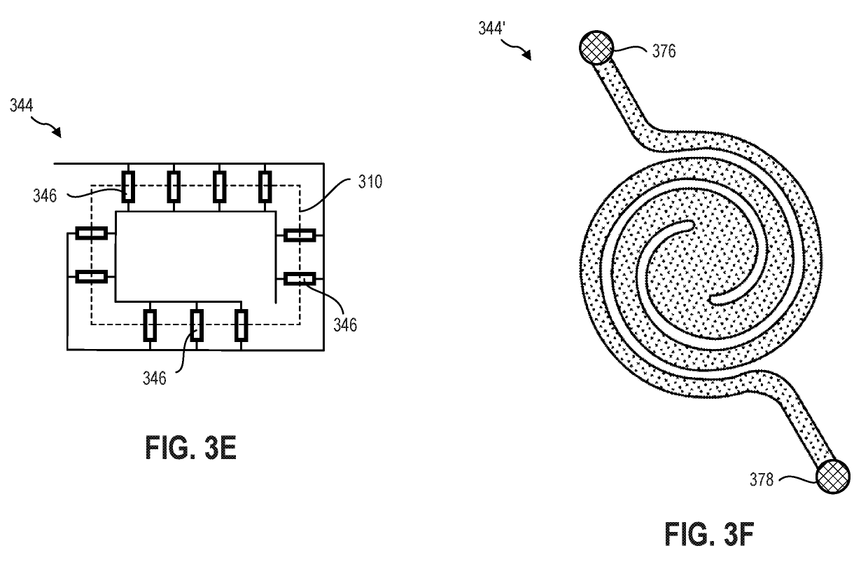

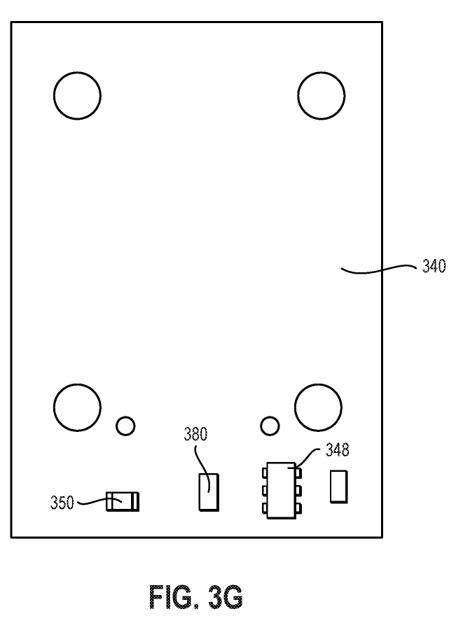

FIG. 3A is a simplified cross-sectional view of a device (also referred to herein as a “thermal camera device,” a “board stack,” an “assembly,” or a “camera system”) 300, in accordance with various embodiments of the disclosure. FIG. 3B is a simplified cross-sectional view of a device package (also referred to herein as a “thermal camera device package”) 301 including the device 300 surrounded (e.g., housed) by a housing 302, in accordance with various embodiment of the disclosure. In some embodiments, the device package 301 corresponds to the thermal camera device package 101 and the device 300 corresponds to the thermal camera device 110 described above. It is noted that FIG. 3B has an orientation that is reversed compared to FIG. 3A.

The device 300 may be configured to facilitate capturing one or more images, such as thermal images, of the environment surrounding and proximate the surveillance unit 100, as described above with reference to the thermal cameras of the thermal camera device 110. In some embodiments, the device 300 comprises a thermal camera, such as an IR camera. In some embodiments, the device 300 comprises a thermal sensor, such as an IR sensor.

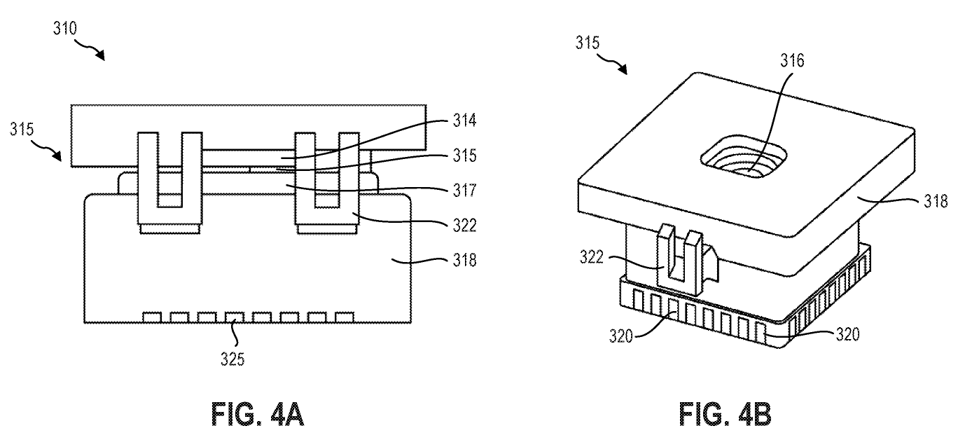

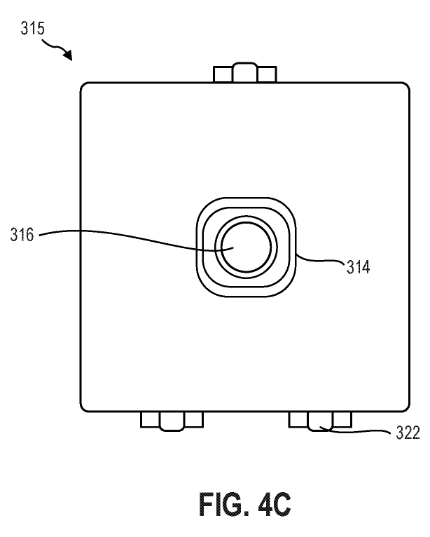

In more detail, and with combined reference to FIGS. 3A and 3B, the device 300 may include a thermal camera assembly 310, which is described in more detail in FIG. 4A; a carrier board 330 to which the thermal camera assembly 310 is operably coupled; a heater device 340 operably coupled to the carrier board 330; and a thermal material 360 between and contacting the heater device 340 and the carrier board 330. As described herein, the thermal material 360 may facilitate transfer of thermal energy (e.g., heat) from the heater device 340 to the thermal camera assembly 310.

The thermal camera assembly 310 may include a thermal camera 315 at least partially housed within and electrically and operably connected to a socket 318. The thermal camera 315 may include a thermal detector 312 (e.g., an IR detector), a shutter 314 integrated with the thermal detector 312, a thermal lens 317, and a protective window 316. The socket 318 may house the thermal camera 315 and electrically and operably connect the thermal camera 315 to the carrier board 330. For example, the socket 318 may be in electrical communication with the carrier board 330 to provide power to the thermal camera 315 and facilitate operable communication between the thermal camera 315 and other components of the surveillance unit 100 (e.g., via a connector 332).

As described in additional detail with reference to FIGS. 4A and 4B, the thermal camera 315 may be at least partially housed within the socket 318. The thermal camera 315 may be in electrical and operable communication with the socket 318 at one or more terminals 320 (FIG. 4B). The thermal camera 315 may be configured to capture or generate thermal data of the environment surrounding the surveillance unit 100 and in the field of view of the thermal camera 315. In some embodiments, the thermal camera 315 generates thermal image data of the environment.

The protective window 316 may be, for example, an IR window, and may be compatible with LWIR wavelengths (8-12 micrometers) and allow for transmissivity above 75%. In some embodiments, the thermal camera assembly 310 includes clips 322 for securing or mounting the thermal camera 315 to the socket 318. In some embodiments, the socket 318 includes tabs configured to interact with the clips 322 to facilitate coupling the thermal camera 315 to the socket 318. The housing 302 may include a transparent window 316 such that infrared radiation is not substantially attenuated through the transparent window 316and reaches the thermal camera 315 substantially unattenuated.

The thermal camera assembly 310 (such as the socket 318) may be operably coupled to the carrier board 330. The carrier board 330 may be between the thermal camera assembly 310 and the heater device 340. For example, the socket 318 may include terminals 325 (e.g., electrical connections) that are electrically and operably coupled to the carrier board 330 at one or more terminals 320 (FIG. 4B) or pins 325 of the carrier board 330. The carrier board 330 may also be referred to as a circuit board assembly of the thermal camera 315.

A connector 332 may be operably coupled to the carrier board 330 and configured to electrically and operably connect the carrier board 330 to other components and circuitry, such as of the head unit 106. In some embodiments, the connector 332 comprises an electrical connector, such as a terminal including pin connectors (e.g., a JST connector). The connector 332 may be configured to, for example, couple to a USB device or USB connector to facilitate electrically and communicatively coupling the thermal camera assembly 310 and the device 300 to a power source, as well as to processing circuitry associated with the surveillance unit 100 (e.g., of the head unit 106). In some embodiments, the connector 332 provides power to the device 300. By way of non-limiting example, the connector 332 may provide a voltage within a range of from about 2 V to about 10 V, such as from about 2 V to about 8 V, from about 3 V to about 7 V, or from about 4 V to about 6 V; and a current within a range of from about 600 mA to about 1,200 mA, such as from about 700 mA to about 1,100 mA, from about 800 mA to about 1,000 mA, or from about 850 mA to about 950 mA. In some embodiments, the connector 332 provides a voltage of about 5 V at a current of about 900 mA, but the disclosure is not so limited to such particular voltages and currents.

The carrier board 330 may further include additional circuitry 334 (see FIG. 3A) and components to facilitate operation of the device 300 including the thermal camera assembly 310 and the heater device 340.

With reference to FIGS. 3A and 3B, the heater device 340 may be in operable and electric communication with the carrier board 330. The heater device 340 may be referred to herein as a “heater printed circuit board assembly (heater PCBA),” a “heater board,” or a “heating system.” The heater device 340 may include a printed circuit board assembly (PCBA) 342 that is operably and electrically coupled to the carrier board 330 and/or to the connector 332. In some embodiments, power is provided to the heater device 340 and the printed circuit board assembly 342 from the carrier board 330, such as by means of one or more electrical connections between the printed circuit board assembly 342 and the carrier board 330. The heater device 340 may be powered via the connector 332.

The heater device 340 may include one or more heating elements 344 configured to provide thermal energy (e.g., heat) to the printed circuit board assembly 342. The heating element 344 may be located on a side of the printed circuit board assembly 342 opposite the thermal material 360. In some embodiments, the heating element 344 directly overlies and contacts the surface of the printed circuit board assembly 342.

The heating element 344 may include one or more (e.g., a plurality of) resistors 346. The resistors 346 may include heating resistors configured to convert electrical energy provided thereto into thermal energy. In some embodiments, the resistors 346 are mounted (attached) to the surface of the printed circuit board assembly 342 and may be referred to as “surface mount resistors.” The resistors 346 may exhibit a relatively low electrical resistance and may be configured to convert an input power to thermal energy (e.g., heat). For example, in some embodiments, the heating element 344 includes eleven 100 Ohm resistors in parallel for a total resistance of 8.3 Ohms. In some embodiments, the resistors 346 are formed of and include an alloy of nickel and chromium, such as Nichrome. By way of non-limiting example, the resistors 346 may include from about 10 atomic percent to about 30 atomic percent chromium; and from about 70 atomic percent to about 90 atomic percent nickel. In some embodiments, the resistors 346 include about 80 atomic percent nickel and about 20 atomic percent chromium.

The heating element 344 may exhibit a total resistance configured to provide a desired amount of thermal energy (e.g., heat) to the thermal camera assembly 310 responsive to the temperature of the device 300 (e.g., the thermal camera 315; see FIG. 3A) falling below a minimum threshold temperature. In some embodiments, the heating element 344 exhibits a total resistance to provide sufficient heat to the thermal camera assembly 310 (e.g., the thermal detector 312) to maintain a temperature of the thermal camera 315 greater than about 0°C, such as from about 8°C to about 10°C, when the ambient temperature is about -40°C. The resistors 346 may be electrically coupled to one another to achieve a desired temperature or heat output for a given current or voltage, which may depend on the power provided by the connector 332.

In some embodiments, each of the resistors 346 exhibit the same resistance. In some embodiments, at least one of the resistors 346 exhibits a different resistance than at least another of the resistors 346. In some embodiments, the total resistance of the heating element 344 is from about 5 Ohms to about 13 Ohms, such as from about 5 Ohms to about 7 Ohms, from about 7 Ohms to about 9 Ohms, from about 9 Ohms to about 11 Ohms, or from about 11 Ohms to about 13 Ohms. In some embodiments, the total resistance of the heating element 344 is about 8.0 Ohms. However, the disclosure is not so limited, and the total resistance of the heating element 344 may be different than that described.

The resistors 346 may be electrically coupled to one another in parallel, in series, or in a combination of parallel and series (e.g., at least some of the resistors 346 are parallel relative to at least some other resistors 346; and in series relative to at least some other resistors 346). The electrical arrangement of the resistors 346 is not limited to any particular arrangement. In some embodiments, the resistors 346 are arranged in a parallel configuration. In such a configuration, the heating element 344 may operated, even if one of the resistors 346 fails without substantially affecting the total resistance and heating output of the circuit.

The resistors 346 may be arranged in any desired pattern on the printed circuit board assembly 342. In some embodiments, the surface area defined by an outline (or lateral boundaries) of the resistors 346 (or the heating element 344) may be the same as or greater than the surface area of the thermal camera assembly 310. In some embodiments, the thermal camera assembly 310 may be located within lateral boundaries defined by the heating element 344. The heating element may be vertically spaced from the thermal camera assembly 310 but may be wider and longer than the thermal camera assembly 310. In some embodiments, outer dimensions defined by the resistors 346 may be as large as or larger than the outer dimensions of the thermal camera assembly 310. For example, in the view of FIG. 3A, the dimension of the resistors 346 in the left and right direction and in and out of the page may be as large as or larger than the dimensions of the thermal camera assembly 310 in the left and right direction. By forming the heating element 344 to have dimensions as large as or larger than (e.g., to overlap) the thermal camera assembly 310, the heating element 344 may provide substantially uniform heat to the thermal camera assembly 310 and reduce any large differences in the temperature of the thermal camera assembly 310, such as hot spots or cold spots.

As described above, the device 300 includes a thermal material 360 between the heater device 340 and the thermal camera assembly 310. In some embodiments, the thermal material 360 is directly between and directly contacts the printed circuit board assembly 342 and the carrier board 330. In some embodiments, the thermal material 360 is directly between and facilitates transfer of thermal energy (e.g., heat) from the heater device 340 to the thermal camera assembly 310. The thermal material 360 may include a thermally conductive tape, a thermally conductive putty, a thermally conductive gel, a thermally conductive foam, a thermally conductive grease, a thermally conductive underfill material, or other suitable thermal transfer medium. In some embodiments, the thermal material 360 comprises a thermally conductive tape. The thermal material 360 may include one or more materials exhibiting a relatively high thermal conductivity. In some embodiments, the thermal material 360 comprises a thermal interface material (TIM).

The thermal material 360 may include, for example, one or more of a polymer material, such as a polymer matrix (e.g., silicone, acrylic, an epoxy) including one or more filler materials. The one or more filler materials may include one or more of aluminum oxide, aluminum nitride, boron nitride, diamond, silver, copper, tungsten, silicon carbide, graphite, graphene, or other materials having a relatively high thermal conductivity. The thermal material may exhibit a bulk thermal conductivity greater than about 1 W/m·K, greater than about 2 W/m·K, such as greater than about 4 W/m·K, greater than about 6 W/m·K, greater than about 8 W/m·K, greater than about 10 W/m·K, greater than about 15 W/m·K, greater than about 20 W/m·K, greater than about 50 W/m·K, greater than about 100 W/m·K, greater than about 200 W/m·K, or even greater than about 250 W/m·K. In some embodiments, the thermal conductivity of the thermal material 360 is about 6 W/m·K. The thermal conductivity of the thermal material 360 may be within a range of from about 4 W/m·K to about 10 W/m·K, such as from about 4 W/m·K to about 8 W/m·K, or from about 5 W/m·K to about 7 W/m·K. However, the disclosure is not so limited, and the thermal conductivity of the thermal material 360 may be different than that described and may be based on the specific properties of the device 300.

With continued reference to FIG. 3A, the heater device 340 may further include a switch 348 in operable communication with the printed circuit board assembly 342. In some embodiments, the switch 348 comprises a thermostat, which may include a temperature sensor. The switch 348 may be configured to determine a temperature (e.g., an ambient temperature, a temperature of the device 300). Responsive to the temperature falling below a minimum threshold temperature (e.g., about 0°C), the switch 348 may be configured to open or close a circuit to provide an output voltage (also referred to a “gate voltage”) to a transistor 350 in electrical and operable communication with the heating element 344. In some embodiments, the switch 348 exhibits hysteresis and is configured to provide power to the transistor 350 (e.g., to power the heating element 344 of the heater device 340 at a first temperature measured by the device 300 and stop powering the heating element 344 at a second temperature measured by the device, the second temperature being higher than the first temperature. After heating the device 300 to the second temperature, the switch 348 may stop providing the voltage to the transistor 350 to stop powering the heating element 344 until the measured temperature falls to the first temperature. The difference between the first temperature and the second temperature may depend on the specific needs and particular design of the device 300. In some embodiments, the second temperature is about 2°C higher than the first temperature.

The thermostat may be a solid-state thermostat or a mechanical thermostat. In some embodiments, the thermostat is a solid-state thermostat and when the temperature sensor measures a temperature less than the minimum threshold temperature, the thermostat provides an output voltage to the transistor 350. In embodiments where the thermostat is a solid-state thermostat, the solid-state thermostat may be adjusted via a single resistor to determine a switching temperature. In some embodiments, the thermostat is a mechanical thermostat and includes, for example, one or more bimetallic strips configured to complete an electric circuit responsive to exposure to a temperature less than the minimum threshold temperature (e.g., less than about 0°C). Responsive to completing the electric circuit, the thermostat may provide the output voltage to the transistor 350. Accordingly, the switch 348 may selectively control when power is provided to the heating element 344 to selectively control when the heating element 344 is powered. In this manner, the device 300 provides heat to the thermal camera assembly 310 based on the ambient temperature (e.g., measured by the temperature sensor of the switch 348). In some embodiments, the switch 348 provides a gate signal to the transistor 350.

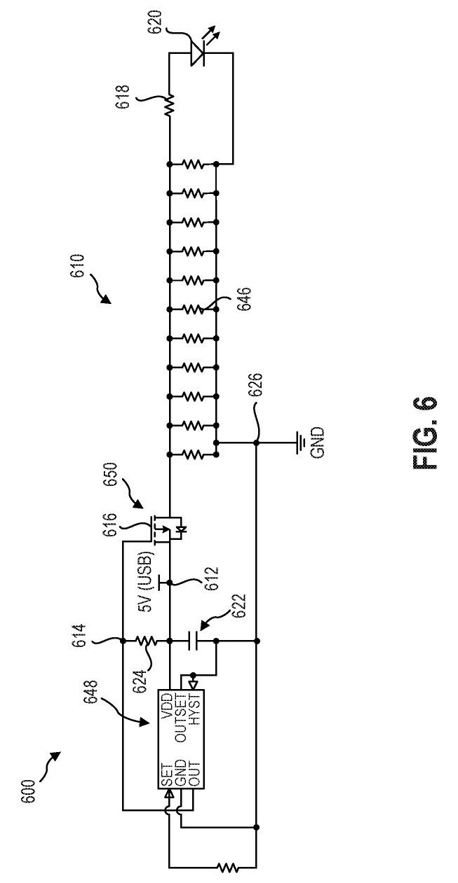

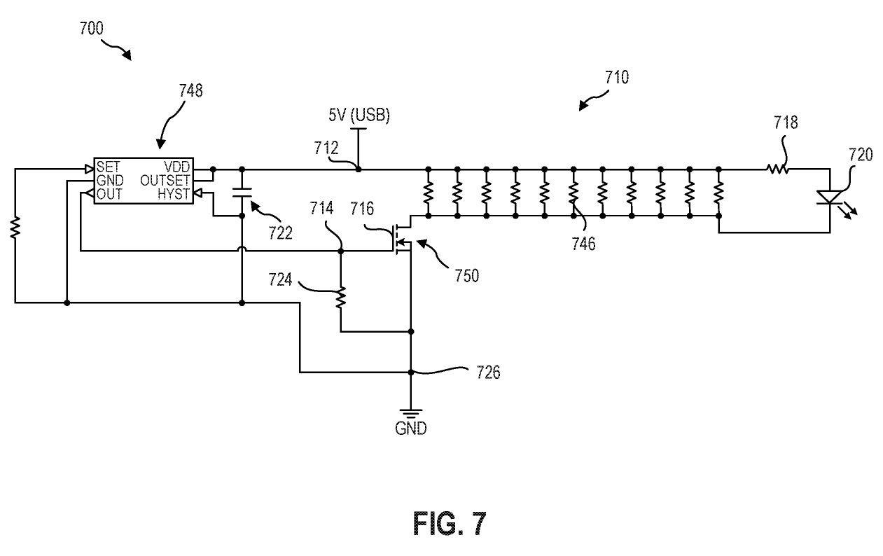

The transistor 350 may include a field-effect transistor (FET) or another transistor configured to receive the output voltage from the switch 348. The transistor 350 may include, for example, a P-channel field-effect transistor and may be used to power the heating element 344 including the resistors 346. In some embodiments, the transistor 350 includes a P-channel field-effect transistor and powers a resistor array in a high-side switch configuration (as described with reference to FIG. 6). In other embodiments, the transistor 350 is an N-channel field-effect transistor that powers a resistor array in a low-side switch configuration (as described with reference to FIG. 7).

With continued reference to FIGS. 3A and 3B, the switch 348 may be in electrical communication with a gate of the transistor 350 such that the output voltage received from the switch 348 causes a conductive channel to flow through the transistor 350. A terminal (e.g., one of the source or the drain) of the transistor 350 may be in electrical communication with the resistors 346. Responsive to receiving the output voltage from the switch 348, a current may flow through the gate of the transistor 350 and provide a power (e.g., a voltage and a current) to the resistors 346. Accordingly, the transistor 350 may facilitate electrical communication between the switch 348 and the heating element 344.

FIG. 3C is a simplified perspective view of the device package 301 in a sealed assembly, in accordance with various embodiments of the disclosure. The housing 302 may comprise an enclosure (e.g., protective enclosure) that substantially (e.g., completely) surrounds the device package 301. The housing 302 may include one or more apertures (e.g., openings) 370 configured to receive a wired connection. For example, an aperture 370 may receive a wire configured to provide electrical and operable communication between the device package 301 and another component of the surveillance unit 100, such as with the one or more batteries in the storage box 104. In some embodiments, the wire is electrically coupled to the connector 332 (see FIGS. 3A and/or 3B).

As described above, and as shown in FIGS. 3A and 3B, the heating element 344 may exhibit a cross-sectional area as large as or larger than a cross-sectional area of the thermal camera assembly 310, such as of the thermal camera 315, the thermal detector 312, and/or the shutter 314. FIG. 3D is a simplified top-down view of the heater device 340 showing a layout of the resistors 346 on the printed circuit board assembly 342, in accordance with various embodiments of the disclosure. An outline of the thermal camera assembly 310 is illustrated in dashed lines in FIG. 3D to illustrate the boundaries and the surface area of the thermal camera assembly 310 relative to the surface area of the printed circuit board assembly 342. In the embodiment illustrated in FIG. 3D, the resistors 346 define an outline and cross-sectional shape that is substantially rectangular. Of course, the resistors 346 may define a different outline, such as a square, a circle, an ellipse, or another shape. The resistors 346 may be arranged in an array pattern including rows 372 and columns 374.

While FIG. 3D illustrates a particular physical layout of the resistors 346, the disclosure is not so limited. In some embodiments, the resistors 346 are arranged in an array pattern. For example, the resistors 346 may be arranged in an array pattern including rows and columns. FIG. 3E is a simplified top-down view showing another layout of how the resistors 346 could be arranged on the printed circuit board assembly 342, in accordance with various embodiments of the disclosure. With reference to FIG. 3E, the resistors 346 may be arranged to define an outline having, for example, a substantially rectangular shape. The cross-sectional area defined by the boundaries of the outline of the resistors 346 may be larger than the cross-sectional area defined by the boundaries of the thermal camera 315. In FIGS. 3D and 3E, the resistors 346 are shown connected in parallel, but the disclosure is not so limited and the resistors 346 may be arranged in series or in a combination of series and parallel.

FIG. 3F is a simplified top-down view of a heating element 344′, in accordance with various embodiments of the disclosure. In some embodiments, the heating element 344′ exhibits a spiral shape. The heating element 344′ may include a single resistive heater configured to increase in temperature responsive to exposure to power (e.g., a voltage and a current). In some embodiments, a first node 376 of the heating element 344′ is in electrical communication with the output of the transistor 350 (see FIGS. 3A and 3B) and a second node 378 is in electrical communication with, for example, a ground voltage.

While FIGS. 3A through 3F have described and illustrated various embodiments of the heating element 344, 344′ and the layout of the resistors 346, the disclosure is not limited to a particular configuration. The heating elements 344, 344′ and the resistors 346 may provide sufficient heat to the thermal camera assembly 310 and the thermal camera 315 to facilitate operation of the thermal camera 315 when the thermal camera 315 is exposed to ambient temperatures below the minimum threshold temperature (e.g., below about 0°C); and to facilitate a substantially uniform temperature profile across the surface area of the thermal camera 315.

FIG. 3G is a simplified planar view of the heater device 340 from a bottom of the heater device 340, in accordance with various embodiments of the disclosure. With reference to FIG. 3G, the back side of the heater device 340 may include contacts and terminals for the switch 348 and the transistor 350. In addition, the heater device 340 may include one or more additional components and/or integrated circuits 380.

FIG. 4A is a simplified cross-sectional view of the thermal camera assembly 310, in accordance with various embodiments of the disclosure. The thermal camera assembly 310 includes the thermal camera 315 disposed (e.g., housed, electrically connected to) within the socket 318. FIG. 4B is a simplified perspective view of the thermal camera 315, in accordance with various embodiments of the disclosure; and FIG. 4C is a simplified top-down view of the thermal camera 315, in accordance with various embodiments of the disclosure. The view of FIG. 4C illustrates the side of the thermal camera 315 including the shutter 314 and the protective window 316 (e.g., which is spaced from the heater device 340 when the thermal camera assembly 310 is attached to the heater device, as shown in FIGS. 3A and 3B).

With reference to FIG. 4B, the thermal camera 315 may include terminals 320 (e.g., electrical connections) configured to couple to (e.g., directly contact, electrically connect to) the terminals 325 (see FIGS. 3A and 3B) of the socket 318 to provide power and operable communication between the socket 318 and the thermal camera 315.

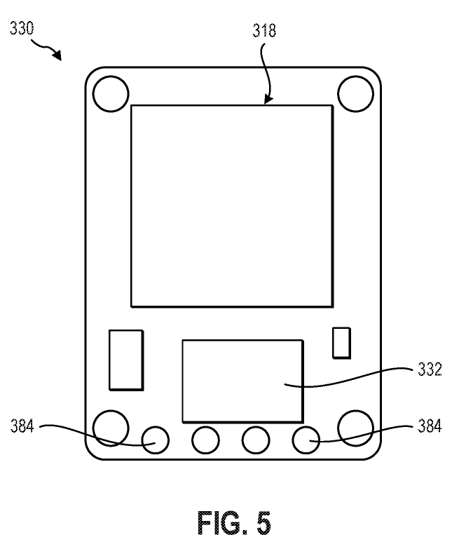

FIG. 5 is a simplified top-down view of the carrier board 330, in accordance with various embodiments of the disclosure. The carrier board 330 may include the socket 318. In addition, the carrier board 330 may include one or more conductive contacts 384 for electrically connecting the carrier board 330 to other components. As shown in FIG. 5, the carrier board 330 includes or is coupled to the connector 332.

FIG. 6 depicts an example circuit 600, according to various embodiments of the disclosure. The circuit 600 includes a resistor array 610 and a P-channel field-effect transistor 650 in a high-side switch configuration. The resistor array 610 may include resistors 646, which may correspond to the resistors 346 described above with reference to FIGS. 3A and/or 3B. The P-channel field-effect transistor 650 may correspond to the transistor 350 (see FIGS. 3A and 3B). As illustrated in FIG. 6, in some embodiments, the resistors 646 are arranged in a parallel configuration. Nodes of the resistors 646 may be in electric communication with a ground voltage node 626 electrically coupled to a ground voltage.

The circuit 600 includes a switch 648, which may correspond to the switch 348 described above with reference to FIGS. 3A and/or 3B. An input node 612 of the circuit 600 may be in electric communication with a power source, such as with the connector 332 (see FIGS. 3A and 3B). The input node 612 may be in electric communication with a drain (e.g., V_{DD}) of the switch 648. As shown, an output node 614 of the switch 648 may be in electric communication with a gate 616 of the P-channel field-effect transistor 650. The resistor array 610 may include a high-side switch configuration wherein the P-channel field-effect transistor 650 remains off by maintaining the bias to the gate 616 at a positive supply voltage when no gate voltage is provided by the switch 648.

With reference to FIG. 6, the circuit 600 may include an additional resistor 618 and a light 620. The light 620 may be configured to provide a visual indication that the resistor array 610 is powered. The light 620 may comprise, for example, a light-emitting diode (LED). In some embodiments, the circuit 600 further includes a capacitor 622 and a resistor 624 configured to facilitate gate biasing and stability of the P-channel field-effect transistor 650, which may be based on the specific switch 648 configuration.

FIG. 7 depicts another example circuit 700, in accordance with various embodiments of the disclosure. The circuit 700 includes a resistor array 710 and an N-channel field-effect transistor 750 in a low-side switch configuration. The resistor array 710 may include resistors 746, which may correspond to the resistors 346 described above with reference to FIGS. 3A and/or 3B. The N-channel field-effect transistor 750 may correspond to the transistor 350 (see FIGS. 3A and 3B). As illustrated in FIG. 7, in some embodiments, the resistors 746 are arranged in a parallel configuration.

The circuit 700 includes a switch 748, which may correspond to the switch 348 described above. An input node 712 of the circuit 700 may be in electric communication with a power source, such as with the connector 332. The input node 712 may be in electric communication with a drain of the switch 748. As shown, an output node 714 of the switch 748 may be in electric communication with a gate 716 of the N-channel field-effect transistor 750. The resistor array 710 may include a low-side switch configuration wherein the resistor array 710 is powered by connecting and disconnecting nodes of the resistors 746 to the ground voltage by opening and closing the gate 716 of the N-channel field-effect transistor 750. Thus, since the resistor array 710 is in a low-side switch configuration, nodes of the resistors 746 may be in electric communication with a ground voltage node 726 electrically coupled to a ground voltage by opening and closing the gate 716 of the N-channel field-effect transistor 750.

As described with reference to the circuit 600, the circuit 700 may include an additional resistor 718 and a light 720. The light 720 may be configured to provide a visual indication that the resistor array 710 is powered and may be the same as the light 620. In some embodiments, the circuit 700 further includes a capacitor 722 and a resistor 724 configured to facilitate gate biasing and stability of the N-channel field-effect transistor 750, which may be based on the specific switch 748 configuration.

While the resistors 646, 746 of FIGS. 6 and 7 have been described and illustrated as being in a parallel configuration, the disclosure is not so limited. As described above, the resistors 646, 746 may be arranged in a series configuration, or a combination of series and parallel wherein at least some of the resistors 646, 746 are parallel with at least other resistors 646, 746 and in series with at least some other of the resistors 646, 746 of the respective resistor arrays 610, 710.

As described above, the resistors 646, 746 (e.g., of a resistor array 610/710) can be any value and any combination of series, series/parallel, or parallel connection in order to achieve a desired power rating and heat for the thermal camera assembly 310. By way of non-limiting example, each resistor 646, 746 in the resistor arrays 610, 710 may be either 91 Ohm or 100 Ohm resistors. In another example, the resistors 646, 746 may be 150 Ohm resistors used in parallel.

Other embodiments may include methods of fabricating a device (e.g., device 300; see FIGS. 3A and 3B) including a thermal camera (e.g., thermal camera 315; see FIGS. 3A and 3B) and a heater printed circuit board assembly (e.g., heater device 340; see FIGS. 3A and 3B) and/or other components thereof. Further, methods of use (e.g., in mobile security/surveillance applications or otherwise) are within the scope of the disclosure.

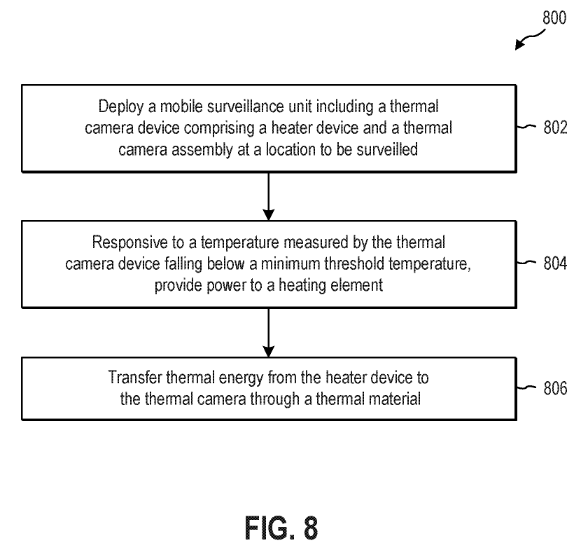

FIG. 8 is a simplified flow diagram illustrating a method 800 of operating a mobile surveillance unit, in accordance with various embodiments of the disclosure. The method 800 includes deploying a mobile surveillance unit including a thermal camera device comprising a heater printed circuit board assembly and a thermal camera assembly at a location to be surveilled, as shown in act 802. In some embodiments, and as described above, the mobile surveillance unit may be deployed at locations where the ambient temperature may fall below a threshold minimum ambient temperature. The mobile surveillance unit may be the same as the surveillance unit 100 described above. The thermal camera and the heater printed circuit board assembly may be the same as those described and may form a part of a device, such as device 300 described above.

The method 800 further includes, responsive to a temperature measured by the thermal camera device falling below a minimum threshold temperature, providing power to a heating element of the heater printed circuit board, as shown in act 804. In some embodiments, the heater printed circuit board includes a thermostat or switch (e.g., switch 348) configured to provide a voltage to a transistor (e.g., transistor 350) responsive to the measured temperature falling below the threshold minimum temperature. In some embodiments, the measured temperature is the ambient temperature. In some embodiments, the measured temperature is a temperature of the thermal camera device, such as of the thermal camera of the thermal camera assembly and/or proximate the thermal camera.

Responsive to providing power to the heating element, the method 800 further includes transferring thermal energy from the heater printed circuit board to the thermal camera through a thermal material, as shown in act 806. The thermal material may be the same as that described above with reference to the thermal material 360. Transferring thermal energy from the heater printed circuit board to the thermal camera may facilitate maintaining an operating temperature of the thermal camera above a minimum operating temperature of the thermal camera.

Accordingly, mobile surveillance units may be configured to operate in conditions where the ambient temperature falls below a threshold minimum temperature, such as below about 0°C. In some embodiments, the surveillance unit may operate at temperatures as low as about -40°C. In particular, mobile surveillance units may include thermal cameras configured to capture thermal images (e.g., IR images) of the surrounding environment. Such thermal cameras may require calibration during use and operation to facilitate accurate operation of the thermal camera. Calibration may include opening and closing the shutter of the thermal camera. In some embodiments, thermal cameras are programmed with logic that causes the shutter not to open or close when temperatures fall below about 0°C. According to embodiments described herein, the switch 348 (e.g., thermostat) may provide power to the transistor 350 and/or the heating element 344 to provide thermal energy to the thermal camera 315. Responsive to receiving a gate voltage from the switch 348, the transistor 350 provides power to the heating element 344, which causes the heater device 340 to be heated. The heat is transferred from the heater device 340 to the thermal camera assembly 310 and the thermal camera 315 through the thermal material 360, which exhibits a relatively high thermal conductivity. The heat provided to the thermal camera 315 increases the temperature of the thermal camera 315 in a substantially uniform manner, allowing the thermal camera 315 to operate accurately and to perform calibration operations (including opening and closing the shutter 314), even when the ambient temperature is as low as about -40°C.

### EXAMPLES

### Example 1

A device including a camera package including a thermal camera and a heater printed circuit board assembly was assembled. The device was substantially similar to the device 300. The heater printed circuit board assembly included a resistor array including eleven 100 Ohm resistors in a parallel configuration to output a total resistance of 8.3 Ohms. Power was provided to the device through a single USB port with a 5 V and 900 mA specification. When the heated printed circuit board was operated, the 5V across the 8.3 Ohms resulted in a current draw of 588 mA, equivalent to about 2.9 W. During operation, the thermal camera drew about 70 mA at 5 V, equivalent to about 0.35 W. When the shutter was activated, the combined current used by the thermal camera (including the shutter) was about 220 mA for about 500 milliseconds. The amount of power required to maintain an internal operating temperature of from about 8°C to about 10°C of the thermal camera when the ambient temperature was about -40°C is about 2.9 W, although the power requirements vary based on the duty cycle of the shutter and the resistors switching on and off based on the temperature. The combined heating capacity of the resistive heater was sufficient to maintain an operating temperature from about 8°C to about 10°C of the thermal camera when the ambient temperature was about -40°C and the heater printed circuit board assembly was mechanically coupled to the printed circuit board assembly of the thermal camera via thermally conductive tape and the entire device was encapsulated in a plastic enclosure.

In accordance with common practice, the various features illustrated in the drawings may not be drawn to scale. The illustrations presented in the disclosure are not meant to be actual views of any particular apparatus (e.g., device, system, etc.), but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. As used herein, “and/or” includes any and all combinations of one or more of the associated listed items.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the term “approximately” or the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed:

1. A surveillance unit, comprising:
a portable trailer;
a mast coupled to the portable trailer; and
at least one thermal camera device coupled to the mast, the at least one thermal camera device comprising:
a heater device including one or more resistors;
a carrier board attached to the heater device;
a camera socket attached to the carrier board; and
a thermal camera including a shutter attached to the camera socket.

2. The surveillance unit of claim 1, wherein the thermal camera device further comprises a thermal material between the heater device and the carrier board.

3. The surveillance unit of claim 2, wherein the thermal material comprises a thermally conductive tape or a thermally conductive putty.

4. The surveillance unit of claim 1, wherein the at least one thermal camera device further comprises an enclosure including the heater device, the carrier board, the camera socket, and the thermal camera.

5. The surveillance unit of claim 1, wherein the at least one thermal camera device further comprises a transistor in electrical communication with the one or more resistors.

6. The surveillance unit of claim 5, wherein the transistor is configured to provide a voltage to the one or more resistors responsive to an ambient temperature falling below a minimum threshold temperature.

7. The surveillance unit of claim 1, wherein the at least one thermal camera device further comprises a switch configured to provide a gate voltage to a transistor in electrical communication with the one or more resistors responsive to an ambient temperature falling below a minimum threshold temperature.

8. The surveillance unit of claim 7, wherein the switch comprises a thermostat.

9. The surveillance unit of claim 7, wherein the switch comprises a temperature sensor and a thermostat, the thermostat configured to provide a gate voltage to a transistor in electric communication with the one or more resistors responsive to the temperature sensor measuring a temperature lower than the minimum threshold temperature.

10. The surveillance unit of claim 1, wherein the one or more resistors comprises a plurality of heating resistors.

11. The surveillance unit of claim 1, wherein the one or more resistors define a heating element, the heating element having a larger surface area than a surface area of the thermal camera.

12. A device, comprising:
a heater device including one or more resistors configured to generate heat;
a carrier board coupled to the heater device via a thermal material; and
a thermal camera attached to the carrier board.

13. The device of claim 12, wherein the thermal camera comprises a long-wave infrared (LWIR) camera.

14. The device of claim 12, wherein the thermal camera comprises a shutter.

15. The device of claim 12, further comprising an enclosure including the heater device, the carrier board, a camera socket, and the thermal camera.

16. The device of claim 12, wherein the heater device further comprises a transistor configured to provide a voltage to the one or more resistors.

17. The device of claim 16, further comprising a switch configured to provide a gate voltage to the transistor responsive to an ambient temperature falling below a minimum threshold temperature.

18. The device of claim 12, wherein the one or more resistors define a cross-sectional area larger than a cross-sectional area of the thermal camera.

19. A method of operating a surveillance unit including a thermal camera, the method comprising:
deploying a surveillance unit including a thermal camera device comprising a heater printed circuit board assembly and a thermal camera assembly at a location;
responsive to a temperature measured by the thermal camera device falling below a minimum threshold temperature, providing power to a heating element of the heater printed circuit board assembly; and
transferring thermal energy from the heater printed circuit board assembly to the thermal camera assembly through a thermal material to increase the temperature of the thermal camera.

20. The method of claim 19, further comprising generating thermal images with the thermal camera after increasing the temperature of the thermal camera.
